(19) United States
(12) Patent Application Publication
(10) Pub. No.: US 2012/0147097 A1
(43) Pub. Date: Jun. 14, 2012

(54) MICRO-EJECTOR AND METHOD OF MANUFACTURING THE SAME

(75) Inventors: Sang Jin KIM, Suwon (KR); Suk Ho Song, Ansan (KR); Bo Sung Ku, Suwon (KR)

(73) Assignee: SAMSUNG ELECTRO-MECHANICS CO., LTD.

(21) Appl. No.: 13/116,493

(22) Filed: May 26, 2011

(30) Foreign Application Priority Data
Dec. 10, 2010 (KR) 10-2010-0126220

(51) Int. Cl. B41J 2/045; B21D 53/76

(52) U.S. Cl. 347/71; 29/890.1

(57) ABSTRACT

There are provided a micro-ejector and a method of manufacturing the same. The micro-ejector includes an upper substrate including an inlet into which a fluid is drawn from the outside and a chamber groove; a lower substrate including a reservoir groove to provide a reservoir storing the fluid drawn through the inlet; a piezoelectric actuator formed on the upper substrate and supplying a driving force for fluid ejection to a chamber; and at least one support protruding from a bottom of the reservoir groove so as to support the upper substrate.

### CROSS-REFERENCE TO RELATED APPLICATIONS

This application claims the priority of Korean Patent Application No. 10-2010-0126220 filed on Dec. 10, 2010, in the Korean Intellectual Property Office, the disclosure of which is incorporated herein by reference.

### BACKGROUND OF THE INVENTION

1. Field of the Invention

The present invention relates to a micro-ejector and a method of manufacturing the same.

2. Description of the Related Art

Biotechnology is one of the most prominent fields of knowledge among highly-developed modern high-technologies. In general, since many samples used in the biotechnology are related to the human body, a micro-liquid system for performing the transporting, controlling and analyzing of a micro-fluid sample present in a fluid or dissolved in a fluid medium is necessary in the field of biotechnology.

The micro-fluid system uses micro electro mechanical systems (MEMS) technology and is applied in various fields such as the continuous in vivo-injection of drugs such as insulin or bioactive substances, a lab-on-a-chip, a chemical analysis for new drug development, an inkjet printing, a small cooling system, a small fuel cell, and the like.

In the micro-fluid system, as an essential component for transporting the fluid, a micro-ejector is used, and particularly, in the case of the micro-ejector for transporting a medical biomaterial, since the micro-ejector deals with high viscous and conductive fluids, due to the characteristic of the biomaterial, a micro-ejector having a piezoelectric element is usually used.

The micro-ejector using a piezoelectric element may include a substrate having a channel (a flow path) formed therein, through which the fluid is transported and a piezoelectric element formed on the top of the substrate. When voltage is applied to the piezoelectric element, a portion of the substrate between a chamber within the channel formed in the substrate and the piezoelectric element vibrates to thereby change the volume of the chamber, such that the pressure of the fluid in the chamber is changed, allowing the fluid to be ejected through a nozzle.

As such, when a portion of the substrate vibrates, the vibration is transferred to other portions of the substrate and particularly, an upper portion of a groove for forming a reservoir storing the fluid may be damaged, because of a thickness thereof smaller than the other portions of the substrate.

Further, in order to apply a power source to the piezoelectric element from an external power source, when a component for the electric connection of the piezoelectric element, for example, a connection pin, is disposed in the upper portion of the groove, the pressure applied by the connection pin is required to be maintained.

### SUMMARY OF THE INVENTION

An aspect to the present invention provides a micro-ejector in which a substrate having a channel formed therein could be stably maintained from vibrations transferred by the piezoelectric element and pressure applied by a component used for the electric connection of the piezoelectric element, and a method of manufacturing the same.

According to an aspect of the present invention, there is provided a micro-ejector including: an upper substrate including an inlet into which a fluid is drawn from the outside and a chamber groove; a lower substrate including a reservoir groove to provide a reservoir storing the fluid drawn through the inlet; a piezoelectric actuator formed on the upper substrate and supplying a driving force for fluid ejection to a chamber; and at least one support protruding from a bottom of the reservoir groove so as to support the upper substrate.

The at least one support may be formed to support a portion of the lower substrate corresponding to an electric connecting part for applying voltage to the piezoelectric actuator of the upper substrate.

The micro-ejector may further include a filter formed towards the chamber in the reservoir groove so as to prevent blockages in the channel. The filter may have a mesh structure.

The micro-ejector may further include a restrictor groove formed between the chamber and the reservoir so as to prevent the fluid in the chamber from flowing backward to the reservoir in any one of the upper substrate and the lower substrate, wherein the filter may be disposed towards the restrictor groove in the reservoir groove.

The micro-ejector may further include a sealing member formed on a top portion of the inlet so as to seal the fluid drawn from the outside.

The upper substrate may include a nozzle groove for ejecting the fluid, and the nozzle groove is formed to eject the fluid in a direction perpendicular to a direction of pressure applied to the chamber.

According to another aspect of the present invention, there is provided a method for manufacturing a micro-ejector including: forming a chamber groove and an inlet into which a fluid is drawn from the outside in an upper substrate; forming a reservoir groove in a lower substrate; forming at least one support in the reservoir groove so as to support the upper substrate; coupling the upper substrate with the lower substrate to forma channel therein; and forming a piezoelectric actuator supplying a driving force for fluid ejection on a portion corresponding to the chamber groove of the upper substrate.

The forming of at least one support may be formed on a portion of the lower substrate corresponding to an electric connecting part for applying voltage to the piezoelectric actuator of the upper substrate.

The method may further include forming a filter formed towards the chamber in the reservoir groove so as to prevent blockages in the channel.

The method may further include attaching a sealing member to a top portion of the inlet so as to seal the fluid drawn from the outside.

The forming of the at least one support and the forming of the reservoir groove may be simultaneously performed.

At this time, the at least one support and the reservoir groove may be formed by etching the lower substrate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view of a micro-ejector according to a first exemplary embodiment of the present invention;

FIG. 2 is a vertical cross-sectional view of a micro-ejector according to the first exemplary embodiment of the present invention;

FIG. 3 is a diagram illustrating a channel structure of a micro-ejector according to a second exemplary embodiment of the present invention;

FIG. 4 is a vertical cross-sectional view of a micro-ejector according to a third exemplary embodiment of the present invention;

FIG. 5 is a plan view of a micro-ejector according to a third exemplary embodiment of the present invention;

FIG. 6 is a process diagram illustrating a process forming a channel in an upper substrate in a method of manufacturing the micro-ejector according to the first exemplary embodiment of the present invention;

FIG. 7 is a process diagram illustrating a process forming a channel in a lower substrate in the method of manufacturing the micro-ejector according to the first exemplary embodiment of the present invention;

FIG. 8 is a process diagram illustrating a process completing a micro-ejector in the method of manufacturing the micro-ejector according to the first exemplary embodiment of the present invention;

FIG. 9 is a diagram illustrating fluid and power suppliers of a micro-ejection apparatus on which the micro-ejector according to the first exemplary embodiment of the present invention is mounted; and

FIG. 10 is a diagram illustrating a case in which the micro-ejector according to the first exemplary embodiment of the present invention is mounted on a micro-ejection apparatus.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. While those skilled in the art could readily devise many other varied embodiments that incorporate the teachings of the present invention through the addition, modification or deletion of elements, such embodiments may fall within the scope of the present invention.

The same or equivalent elements are referred to by the same reference numerals throughout the specification.

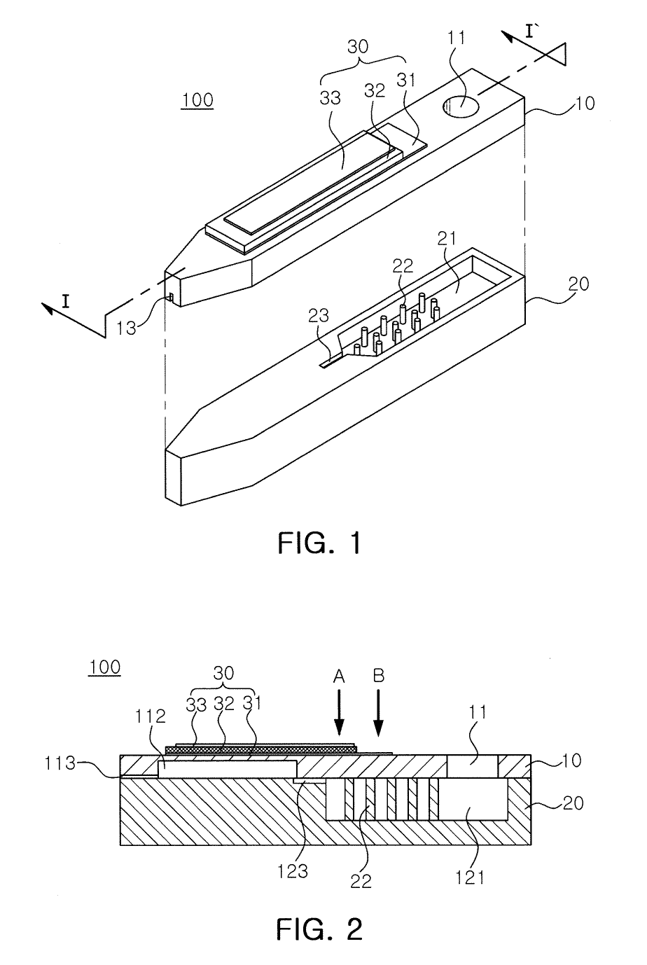

FIG. 1 is an exploded perspective view of a micro-ejector according to a first exemplary embodiment of the present invention and FIG. 2 is a vertical cross-sectional view of a micro-ejector according to the first exemplary embodiment of the present invention.

Referring to FIGS. 1 and 2, a micro-ejector 100 according to the first exemplary embodiment of the present invention includes an upper substrate 10 and a lower substrate 20 in which a channel is formed and a piezoelectric actuator 30 supplying a driving force for ejecting a fluid into the channel.

The upper substrate 10 and the lower substrate 20 may be formed of a single crystal silicon substrate or a silicon on insulator (SOI) wafer having two silicon layers and an insulating layer disposed therebetween. At this time, both of the upper substrate 10 and the lower substrate 20 may be formed of a single crystal silicon substrate or a SOI wafer, or one of the upper substrate 10 and the lower substrate 20 maybe formed of a single crystal silicon substrate and the other may be formed of a SOI wafer.

The upper substrate 10 includes an inlet 11 into which a fluid is drawn from the outside, a chamber groove 12, and a nozzle groove 13.

The inlet 11 is formed by penetrating the thickness of the upper substrate 10 and the chamber groove 12 and the nozzle groove 13 are formed by being depressed upward in a thickness direction of the upper substrate 10. These grooves may be formed by dry or wet etching.

The lower substrate 20 may include a reservoir groove 21 and a restrictor groove 23. The restrictor groove 23 may be formed on the upper substrate 10.

Supports 22 disposed on the top of the reservoir groove 21 to support a portion (reservoir forming part) of the upper substrate 10 forming a reservoir 121 may be formed in the reservoir groove 21.

The supports 22 may be protruded from the bottom of the reservoir groove 21 and may be extended so as to contact the reservoir forming part of the upper substrate 10. The support 22 may be at least one or more.

The reservoir groove 21 and restrictor groove 23 may be formed by dry or wet etching the lower substrate 20, and reservoir groove 21 and the supports 22 may be simultaneously formed by etching the rest portions except for the portion of the supports 22 when the reservoir groove 21 is formed.

By bonding the upper substrate 10 and the lower substrate 20 having the grooves for forming the channel, the reservoir 121 storing the fluid drawn through the inlet 11, a nozzle 113 ejecting the fluid to the outside, a chamber 112 transporting the fluid to the nozzle 113, and a restrictor 123 preventing the fluid in the chamber 112 from flowing backward to the reservoir 121 are formed.

The piezoelectric actuator 30 is formed on the upper surface of the upper substrate 10 in such a manner as to correspond to the chamber 112 and may include a lower electrode acting as a common electrode, a piezoelectric film 32 deformed according to applied voltage, and an upper electrode 33 acting as a driving electrode.

The lower electrode 31 may be formed on the surface of the upper substrate 10 and made of a conductive metal material, but maybe formed of two thin metal layers made of titanium (Ti) and platinum (Pt).

The piezoelectric film 32 is formed on the lower electrode 31 and disposed above the chamber 112. The piezoelectric film 32 may be made of a piezoelectric material, preferably a lead zirconate titanate (PZT) ceramic material.

The upper electrode 33 may be formed on the piezoelectric film 32 and made of any one material of Pt, Au, Ag, Ni, Ti, Cu, and the like.

In the lower electrode 31 and the upper electrode 33, electric connecting parts A and B contacting a connecting member for electric connection with an external power source may be formed at the outside of the chamber 112, that is, towards the reservoir 121.

To this end, the piezoelectric film 32 and the upper electrode 33 may extend toward the reservoir 121 in a longitudinal direction of the chamber 112 for the length of the electric connecting part A on the upper electrode 33, and the lower electrode 31 may further extend from the piezoelectric film 32 and the upper electrode 33 for the length of the electric connecting part B on the lower substrate 31.

At this time, the supports 22 may be formed at a corresponding portion to the electric connecting parts A and B. Accordingly, the reservoir forming part of the upper substrate 10 may be supported by the supports 22 from pressure applied by the connecting member contacting the electric connecting parts A and B, for example, the connection pin.

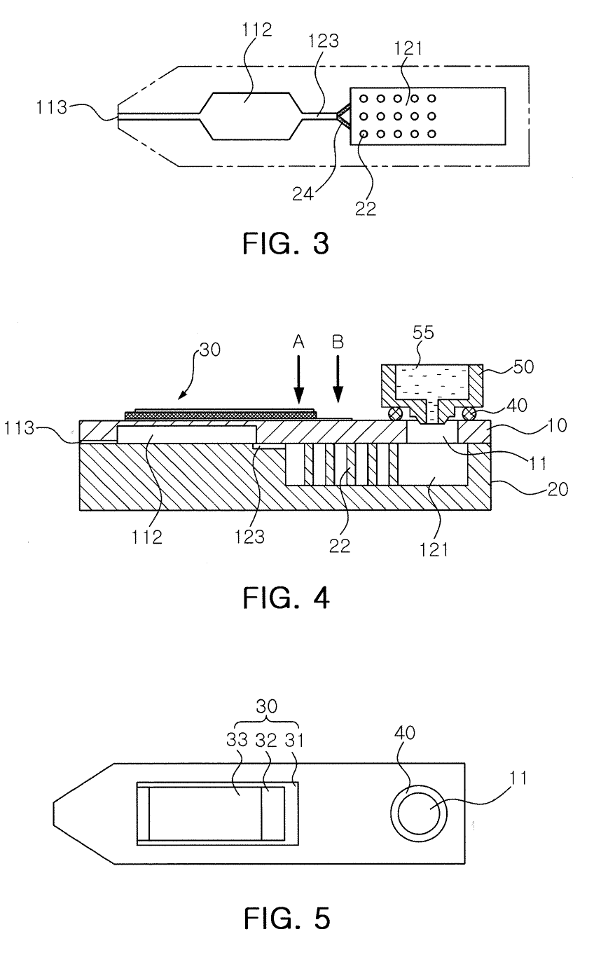

FIG. 3 is a diagram illustrating a channel structure of a micro-ejector according to a second exemplary embodiment of the present invention.

As shown in FIG. 3, the micro-ejector according to the second exemplary embodiment of the present invention further includes a filter in the channel and components except for the filter are the same as in the micro-ejector according to the first exemplary embodiment shown in FIGS. 1 and 2. Accordingly, the detailed description for the same components will be omitted and hereinafter, the different component will be described.

Referring to FIG. 3, the micro-ejector according to the second exemplary embodiment of the present invention may further include a filter 24 in the channel. The filter 24 may be formed towards the chamber 112, more particularly, the restrictor 123 in the reservoir 121 side so as to prevent blockages in the channel and formed to have the structure of a mesh in which gaps of a uniform size are formed. At this time, the filter 24 may be formed of a mesh in which gaps having a size equal to or smaller than a diameter of an opening of the nozzle 113 ejecting the fluid are formed.

As a result, since impurities and particles drawn from the outside do not block the opening of the nozzle 113, blockages in the channel may be prevented.

FIG. 4 is a vertical cross-sectional view of a micro-ejector according to a third exemplary embodiment of the present invention and FIG. 5 is a plan view of a micro-ejector according to the third exemplary embodiment of the present invention.

Referring to FIGS. 4 and 5, the micro-ejector according to the third exemplary embodiment of the present invention further includes a sealing member disposed in the inlet into which the fluid is drawn and components except for the sealing member are the same as in the micro-ejector according to the first exemplary embodiment shown in FIGS. 1 and 2. Accordingly, the detailed description for the same components will be omitted and hereinafter, the different component will be described.

Referring to FIGS. 4 and 5, the micro-ejector according to the third exemplary embodiment of the present invention further includes a sealing member 40 disposed on the top of the inlet 11 so as to seal the fluid drawn from the outside.

The sealing member 40 may be formed to cover the circumference of the inlet 11 and may prevent a fluid 55 of a fluid supplier 50 connected to the inlet 11 from being leaked to the outside of the inlet 11. In addition, the sealing member 40 may support the pressure of the fluid supplier 50 connected to the inlet 11. The sealing member 40 may be formed as a ring member or an elastic member.

Hereinafter, a method of manufacturing the micro-ejector according to the first exemplary embodiment of the present invention will be described, the micro-ejector having the above components.

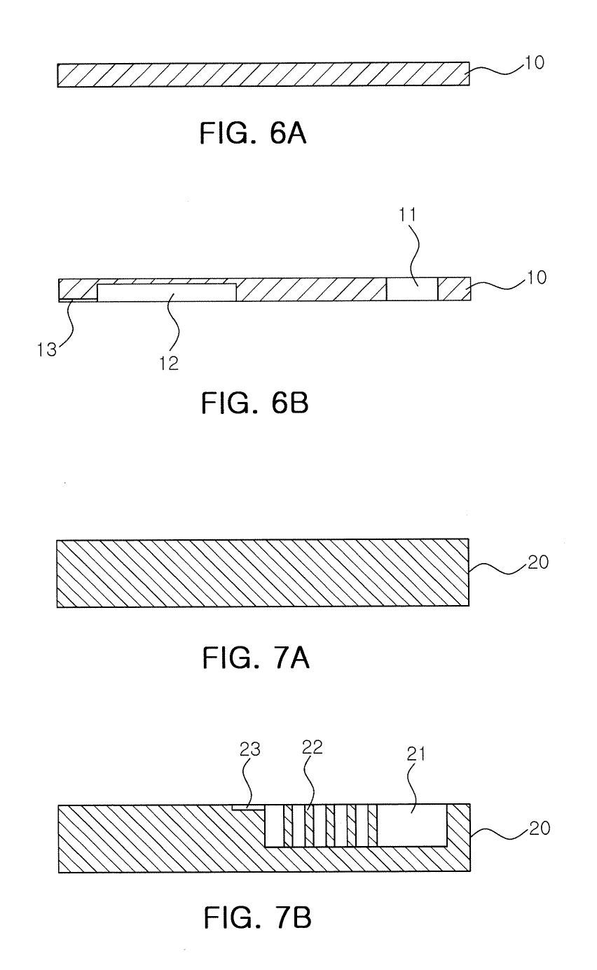

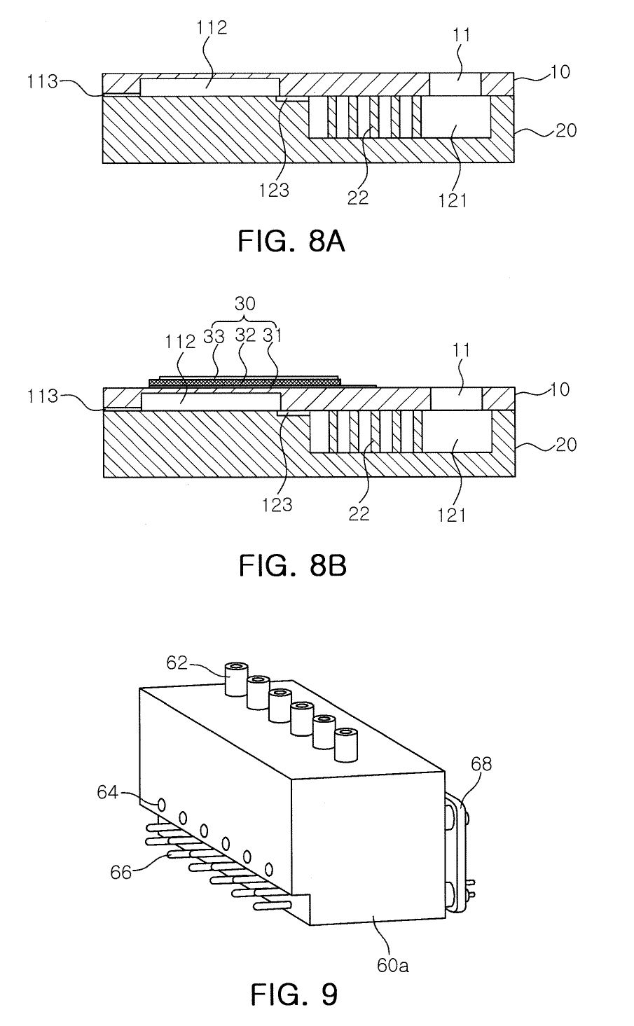

FIG. 6 is a process diagram illustrating a process forming a channel in an upper substrate in a method for manufacturing the micro-ejector according to the first exemplary embodiment of the present invention, FIG. 7 is a process diagram illustrating a process forming a channel in a lower substrate in a method of manufacturing the micro-ejector according to the first exemplary embodiment of the present invention, and FIG. 8 is a process diagram illustrating a process completing a micro-ejector in a method of manufacturing the micro-ejector according to the first exemplary embodiment of the present invention.

First, a method of manufacturing the micro-ejector of the present invention is schematically explained. The micro-ejector according to the exemplary embodiment of the present invention may be completed by forming a channel in the upper substrate and the lower substrate, and stacking and bonding the upper substrate on the lower substrate. Meanwhile, the forming of the channel in the upper substrate and lower substrate may be performed regardless of the order. That is, the channel may be formed in any one of the upper substrate and the lower substrate or both of the upper substrate and the lower substrate at the same time. However, hereinafter, for convenience of the description, the forming of the channel in the upper substrate will be firstly described.

As shown in FIG. 6A, a single crystal silicon substrate having a thickness of approximately 100 to 200 μm is prepared as the upper substrate 10.

Next, as shown in FIG. 6B, the inlet 11, the chamber groove 12, and the nozzle groove 13 are formed in the upper substrate 10 and may be formed by etching using a photoresist.

That is, openings corresponding to the inlet 11, the chamber groove 12, and the nozzle groove 13 are formed by applying the photoresist on the bottom surface of the upper substrate 10 and patterning the applied photoresist. At this time, the patterning of the photoresist is performed by a well-known photolithography method including exposure and development processes and the patterning of other photoresists to be described below may be performed by the same method.

The inlet 11, the chamber groove 12, and the nozzle groove 13 are formed by etching a portion exposed through the opening by using the patterned photoresist as an etch mask. At this time, the upper substrate 10 maybe etched by a dry etching method such as a reactive ion etching (RIE) using an inductively coupled plasma (ICP) or a wet etching method using an etchant for silicon, for example, Tetramethyl Ammonium Hydroxide (TMAH) or potassium hydroxide (KOH). The etching of this silicon substrate may be equally applied to the etching of another silicon substrate to be described below.

The forming of the channel using the single crystal silicon substrate as the upper substrate 10 was shown and described above, but a SOI wafer may also be used as the upper substrate 10.

As shown in FIG. 7A, a single crystal silicon substrate having a thickness of approximately several hundreds μm, preferably about 210 μm is prepared as the lower substrate 20.

Next, as shown in FIG. 7B, the reservoir groove 21, and the restrictor groove 23 are formed by wet and/or dry etching the lower substrate 20 and the forming of these grooves may be formed by etching using the photoresist, similarly to the forming of the channel in the upper substrate 10.

That is, openings for forming the reservoir groove 21 and the restrictor groove 23 are formed by applying the photoresist on the top surface of the lower substrate 20 and patterning the applied photoresist. At this time, the patterning of the photoresist may be performed by the photolithography method described above.

When the opening for forming the reservoir groove 21 is formed, the opening is formed at the rest portions except for the portion forming the supports 22.

Next, the reservoir groove 21 and the restrictor groove 23 are formed by etching a portion exposed through the opening by using the patterned photoresist as an etch mask. At this time, since the portion forming the supports 22 is not exposed, the supports 22 may be formed by the etching of the reservoir groove 21 at once. That is, the forming of the supports 22 and the etching of the reservoir groove 21 may be simultaneously formed.

The lower substrate 20 may be etched by wet etching using TMAH or KOH, or dry etching such as a RIE using an ICP.

The forming of the channel by using the single crystal silicon substrate as the lower substrate 20 was shown and described above, but a SOI wafer may be used as the lower substrate 20.

As shown in FIG. 8A, the upper substrate 10 and the lower substrate 20 having the channel formed therein are bonded. The upper substrate 10 may be stacked on the lower substrate 20 and bonded by a silicon direct bonding (SDB).

That is, as bonding surfaces, the bottom surface of the upper substrate 10 and the top surface of the lower substrate 20 are adhered closely and heat treated, to thereby being bonded to each other.

When the upper substrate 10 and the lower substrate 20 are bonded, the reservoir 121, the restrictor 123, the chamber 112, and the nozzle 113 may be formed as the channel.

Next, as shown in FIG. 8B, the piezoelectric actuator is formed at a portion on the upper substrate 10, corresponding to the chamber 112. The lower electrode 31 is formed on the surface of the upper substrate 10, the piezoelectric film 32 is formed on the top surface of the lower electrode 31, and then the upper electrode 33 is formed on the piezoelectric film 32.

The upper electrode 33 extends outwardly in the longitudinal direction of the chamber 112, that is, toward the reservoir 121 so as to be electrically connected with an external power source and at this time, the piezoelectric film 32 further extends for the length of the electric connecting part A on the upper electrode 33 in order to support the upper electrode 33.

The lower electrode 31 may also extend outwardly in the longitudinal direction of the chamber 112, that is, toward the reservoir 121 in such a manner as to be longer than the upper electrode 33 and the piezoelectric film 32 so as to be electrically connected with an external power source.

Hereinafter, a micro-ejection apparatus on which the micro-ejector according to the first exemplary embodiment of the present invention is mounted will be described, the micro-ejector including the above components.

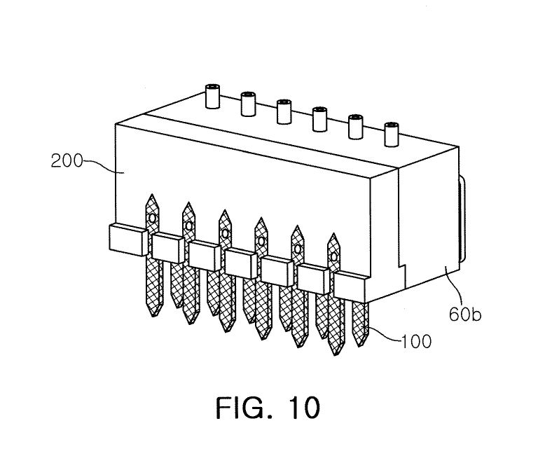

FIG. 9 is a diagram illustrating fluid and power suppliers of a micro-ejection apparatus on which the micro-ejector according to the first exemplary embodiment of the present invention is mounted and FIG. 10 is a diagram illustrating a case in which the micro-ejector according to the first exemplary embodiment of the present invention is mounted.

Referring to FIGS. 9 and 10, a micro-ejection apparatus on which the micro-ejector according to the first exemplary embodiment of the present invention is mounted may include a plurality of the micro-ejector 100, a supporting plate 200, and channel plates 60a and 60b. Since the plurality of the micro-ejector 100 are disposed in two columns in FIGS. 9 and 10, the channel plates also includes the channel plate 60a connected to the micro-ejector set of the first column and the channel plate 60b connected to the micro-ejector set of the second column, but since the structure of the channel plates 60a and 60b are the same, for convenience of the description, hereinafter, the structure of the channel plate 60a will be described.

The support plate 200 includes a mounting groove, whereby the micro-ejector 100 maybe detachably mounted thereon. Accordingly, the micro-ejector 100 may be easily replaced.

The channel plate 60a may include a fluid inlet 62 into which the fluid is drawn, a storage storing the drawn fluid, and a fluid outlet 64 for supplying the fluid to each micro-ejector 100.

The channel plate 60a is coupled with the support plate 200 having the micro-ejector 100 coupled therewith, to thereby fix the micro-ejector 100 thereto, and may be separated from the support plate 200 when the micro-ejector 100 is replaced.

The channel plate 60a includes connection pins 66, formed in the portion corresponding to the piezoelectric actuator 30 of the micro-ejector 100, and acting as a connecting member for applying a power source to the piezoelectric actuator 30 from the external power source.

The connection pins 66 may be formed of a plurality of pins for each micro-ejector and one of the connection pins 66 shown in FIG. 9 may be in contact with the lower electrode 31 and the other may be in contact with the upper electrode 33, respectively.

One side of the channel plate 60a may include a substrate 68 for applying power. Through holes in which the connection pins 66 are inserted may be formed on the substrate 68 for applying power. The connection pins 66 may be inserted into the through holes in a sliding manner when the support plate 200 and the channel plate 60a are coupled to each other.

In the exemplary embodiment, the micro-ejection apparatus including the support plate 200 on which the micro-ejector 100 is mounted and the channel plate 60a supplying the fluid to the micro-ejector 100 is shown and described, but the present invention is not limited thereto and the design may be variously changed for supplying the fluid and the power.

As set forth above, the substrate for forming the channel can be stably maintained from the vibration transferred by the piezoelectric element and the pressure applied by a component for the electrical connection of the piezoelectric element.

While the present invention has been shown and described in connection with the exemplary embodiments, it will be apparent to those skilled in the art that modifications and variations can be made without departing from the spirit and scope of the invention as defined by the appended claims. For example, in the exemplary embodiments of the present invention, the constitution of the channel formed within the micro-ejector is exemplarily shown, and other constitutions other than the channel could be further included. Processing methods for forming the channel may include chemical and mechanical processing in addition to etching processing. Accordingly, the scope of the present invention will be determined by the appended claims.

What is claimed is:

1. A micro-ejector, comprising:
an upper substrate including an inlet into which a fluid is drawn from the outside and a chamber groove;
a lower substrate including a reservoir groove to provide a reservoir storing the fluid drawn through the inlet;
a piezoelectric actuator formed on the upper substrate and supplying a driving force for fluid ejection to a chamber; and
at least one support protruding from a bottom of the reservoir groove so as to support the upper substrate.

2. The micro-ejector of claim 1, wherein the at least one support is formed to support a portion of the lower substrate corresponding to an electric connecting part for applying voltage to the piezoelectric actuator of the upper substrate.

3. The micro-ejector of claim 1, further comprising:
a filter formed towards the chamber in the reservoir groove so as to prevent blockages in the channel.

4. The micro-ejector of claim 3, wherein the filter has a mesh structure.

5. The micro-ejector of claim 3, further comprising:
a restrictor groove formed between the chamber and the reservoir so as to prevent the fluid in the chamber from flowing backward to the reservoir in any one of the upper substrate and the lower substrate, wherein the filter is disposed towards the restrictor groove in the reservoir groove.

6. The micro-ejector of claim 1, further comprising:
a sealing member formed on a top portion of the inlet so as to seal the fluid drawn from the outside.

7. The micro-ejector of claim 1, wherein the upper substrate includes a nozzle groove for ejecting the fluid, and the nozzle groove is formed to eject the fluid in a direction perpendicular to a direction of pressure applied to the chamber.

8. A method of manufacturing a micro-ejector, comprising:
forming a chamber groove and an inlet into which a fluid is drawn from the outside in an upper substrate;
forming a reservoir groove in a lower substrate;
forming at least one support in the reservoir groove so as to support the upper substrate;
coupling the upper substrate with the lower substrate to form a channel therein; and
forming a piezoelectric actuator supplying a driving force for fluid ejection on a portion corresponding to the chamber groove of the upper substrate.

9. The method of claim 8, wherein the forming of at least one support is formed on a portion of the lower substrate corresponding to an electric connecting part for applying voltage to the piezoelectric actuator of the upper substrate.

10. The method of claim 8, further comprising: a filter formed towards the chamber in the reservoir groove so as to prevent blockages in the channel.

11. The method of claim 8, further comprising: attaching a sealing member to a top portion of the inlet so as to seal the fluid drawn from the outside.

12. The method of claim 8, wherein the forming of the at least one support and the forming of the reservoir groove are simultaneously performed.

13. The method of claim 12, wherein the at least one support and the reservoir groove are formed by etching the lower substrate.
